(19) United States
(12) Patent Application Publication
(10) Pub. No.: US 2016/0368585 A1
(43) Pub. Date: Dec. 22, 2016

(54) Process for the manufacture of a fuselage panel by overmolding and fuselage panel so obtained

(71) Applicant: Airbus Operations (SAS), Toulouse (FR)

(72) Inventor: Mathias Farouz-Fouquet, Toulouse (FR)

(21) Appl. No.: 15/186,643

(22) Filed: Jun. 20, 2016

(30) Foreign Application Priority Data
Jun. 19, 2015 (FR) 1555614

(51) Int. Cl. B64C 1/06; B29C 45/26; B29C 45/14

(52) U.S. Cl. CPC B64C 1/068; B29C 45/14344; B29C 45/26; B29C 2045/14368; B29C 2045/14967; B29C 2045/2683; B29L 2031/3082

(57) ABSTRACT

A process for manufacturing an aircraft fuselage panel comprising a skin and at least one reinforcement attached to the skin. The process comprises the stages of shaping a metal sheet so as to obtain the skin and overmolding one or more reinforcements onto the metal sheet. A mold is provided for implementing the process and an aircraft fuselage panel obtained by the process.

### CROSS-REFERENCES TO RELATED APPLICATIONS

This application claims the benefit of the French patent application No. 1555614 filed on Jun. 19, 2015, the entire disclosures of which are incorporated herein by way of reference.

### BACKGROUND OF THE INVENTION

This invention relates to a process for manufacturing a fuselage panel by overmolding and a fuselage panel obtained using the process.

An aircraft fuselage comprises a skin applied to a structure comprising a first series of transverse reinforcements (known as frames) located in transverse planes and a second series of longitudinal reinforcements (known as stringers) located in longitudinal planes.

In the remainder of the description, a longitudinal direction will be parallel to a longitudinal axis extending from the nose to the tail of the aircraft. A longitudinal plane will be a plane containing the longitudinal axis and a transverse plane will be a plane perpendicular to the longitudinal axis.

The fuselage of an aircraft generally comprises several sections located end to end and connected in pairs. Each section extends between two transverse planes and generally comprises a number of panels assembled together.

Some sections of fuselage incorporate openings, such as, for example, windows, which are bounded by reinforcements in the form of a frame attached to the skin.

In a first embodiment, each fuselage panel of an aircraft comprises a sheet of metal, in particular, of aluminum alloy, which acts as the skin and metal reinforcements, in particular, of aluminum alloy.

The metal skin forms a faraday cage that protects the aircraft against lightning.

The various reinforcements are connected directly to the skin by connecting members or through intercalary parts such as, for example, brackets or wedges. These connecting members are attached components such as bolts, rivets, screws, etc.

This first manner of construction is not fully satisfactory because it requires much manipulation and many hours of work, which tends to increase the cost of the fuselage panels. Furthermore, it substantially increases the mass of the aircraft.

According to a second manner of construction, an aircraft fuselage panel is made of composite material. Some reinforcements are connected to the skin by co-curing, as a result of which the attached connecting members such as rivets, bolts and screws can be dispensed with.

Although this second manner of construction makes it possible to reduce the mass of aircraft fuselage panels, it is not fully satisfactory because it is relatively complex to implement. As another disadvantage, the panel of composite material does not have appropriate electrical conductivity, and a metal coating has to be applied to the skin in the form of, for example, a grid in order to ensure protection against lightning.

This addition largely eliminates the mass saving brought about through the use of composite material and increases complexity of construction and thus ultimately the cost of fuselage panels.

### SUMMARY OF THE INVENTION

An object of this invention is to overcome the disadvantages in the prior art.

For this purpose, the invention relates to a process for manufacturing an aircraft fuselage panel comprising a skin and at least one reinforcement attached to the skin, the skin being obtained by shaping a sheet of metal according to the geometry of the skin. In the process, at least one reinforcement is obtained by overmolding.

This solution makes it possible to obtain protection against lightning, the skin being of metal, and to eliminate the attached connecting members linking the reinforcement or reinforcements to the metal sheet, which tends to reduce the mass carried.

Overmolding comprises the stages of:
positioning the metal sheet in a mold comprising a cavity having the same geometry as that of the metal sheet and at least one recess having the same geometry as that of the reinforcement or reinforcements which have to be overmolded, the recess or recesses opening into the cavity,
injecting the material into the recesses in such a way as to obtain the overmolded reinforcement(s),
turning out the metal sheet provided with the overmolded reinforcement or reinforcements.

Advantageously the metal sheet comprises for at least one overmolded reinforcement, at least one opening passing through the metal sheet into which the material is injected. Thus, for each opening, the overmolded reinforcement comprises a projection embedded in the metal sheet.

Preferably, the opening has a cross-section that increases in size between a first surface of the metal sheet on which the overmolded reinforcement is positioned and a second surface of the metal sheet opposite the first surface.

Advantageously, the material is injected into the recess or recesses passing through the opening or openings.

Another object of the invention is a mold for implementing the process, wherein the mold comprises a first shell incorporating a concave shape corresponding to a first surface of the skin of the fuselage panel, a second shell incorporating a convex shape corresponding to a second surface of the skin of the fuselage panel, at least one of the first and second shells being capable of being moved so as to occupy a closed position in which the first and second shells bound a cavity having a geometry identical to that of the skin and a parted position, the second shell comprising at least one recess having a geometry identical to that of a reinforcement which has to be overmolded onto the skin.

Preferably, the first shell comprises at least one feed channel for the material that has to be injected, the channel being positioned in such a way as to open out into an opening provided in a metal sheet forming the skin and positioned in the cavity bounded by the first and second shells in the closed position.

Yet another object of the invention is an aircraft fuselage panel comprising at least one overmolded reinforcement obtained using the process.

### BRIEF DESCRIPTION OF THE DRAWINGS

Other characteristics and advantages will be apparent from the following description of the invention provided purely by way of example with respect to the appended drawings in which:

FIG. 1A is a perspective view of a first shell of an injection molding mold illustrating a first embodiment of the invention,

FIG. 1B is a perspective view of a second shell of an injection molding mold illustrating a first embodiment of the invention,

FIG. 2 is a cross-section of an injection molding mold illustrating another embodiment of the invention,

FIG. 3 is a perspective view of an aircraft fuselage panel constructed in accordance with the process according to the invention,

FIG. 4 is a cross-section along the line IV-IV in FIG. 3,

FIG. 5 is a transverse cross-section of a section of aircraft fuselage obtained by assembling fuselage panels constructed in accordance with the process according to the invention,

FIG. 6 is a cross-section along the line VI-VI in FIG. 5,

FIG. 7 is a cross-section along the line VII-VII in FIG. 5,

FIG. 8 is a perspective view illustrating a detail in FIG. 5.

### DETAILED DESCRIPTION OF THE PREFERRED EMBODIMENTS

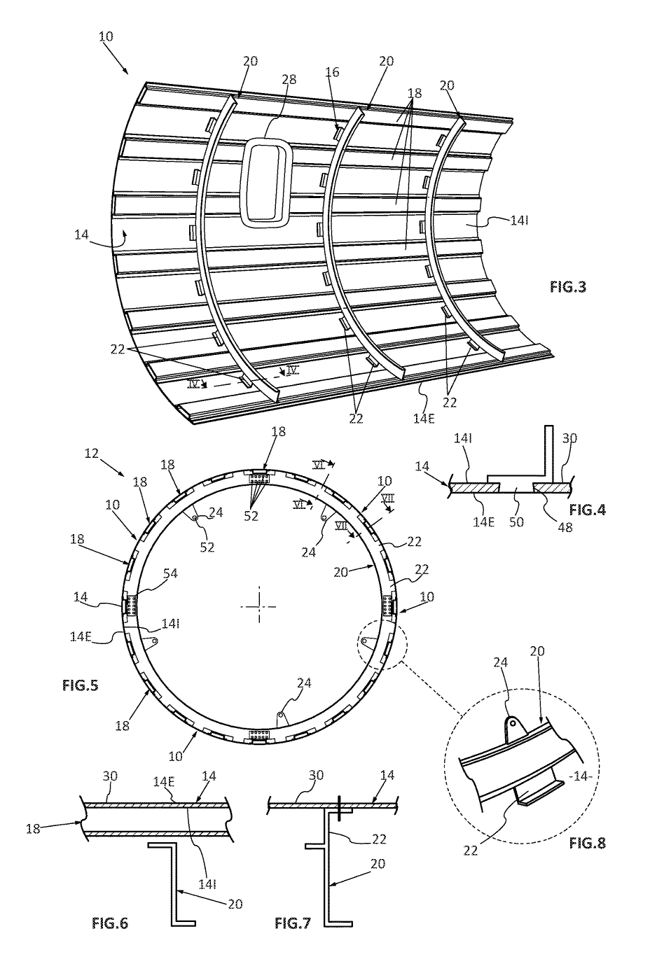

An aircraft fuselage panel is shown as 10 in FIG. 3. As illustrated in FIG. 5, several panels 10 can be assembled so as to form a section 12. Sections 12 are assembled end-to-end to form an aircraft fuselage. The fuselage comprises a skin 14 with an inner surface 141 orientated towards the interior of the fuselage and an outer surface 14E orientated towards the outside of the fuselage. This skin 14 is attached to a structure 16 comprising longitudinal reinforcements 18 (known as stringers) and transverse reinforcements 20 (known as frames).

In accordance with one embodiment, longitudinal reinforcements 18 are located in longitudinal planes and abut against the inner surface 141 of the skin 14. Depending upon configurations, a longitudinal reinforcement 18 will have a transverse cross-section (in a transverse plane) in the shape of an I, L, or omega. Other shapes for the cross-section of the longitudinal reinforcements 18 may be envisaged.

Each transverse reinforcement 20 forms a ring located in a transverse plane and has shapes allowing for the passage of the longitudinal reinforcements 18. In accordance with a first variant, the transverse reinforcements 20 comprise cut-outs to allow passage for the longitudinal reinforcements 18. According to another variant which will be seen in FIGS. 3 and 5 to 8, each transverse reinforcement 20 is at a distance from the skin 14 and includes pads 22 connecting the transverse reinforcement to the skin 14, the pads 22 being spaced to allow passage for the longitudinal reinforcements 18. According to one embodiment illustrated in FIGS. 6 and 7, the transverse reinforcement has a Z-shaped cross-section, the central part of the Z shape located in a transverse plane being extended by L-shaped pads 22. Other shapes for the cross-section of the transverse reinforcements 20 may be envisaged.

As illustrated in FIGS. 5 and 8, the reinforcements, in particular the transverse reinforcements 20, incorporate excrescences 24 providing an attachment for securing at least one component to the structure of the aircraft.

As illustrated in FIG. 3, an aircraft fuselage also comprises openings 26 obstructed by fixed members as in the case of a window or obstructed by movable members as in the case of a door. Each opening 26 is bounded by at least one reinforcement 28 extending over the perimeter of the opening which is of one piece with the skin 14. The reinforcements 28 have different cross-sections depending upon the function of the opening.

As illustrated in FIG. 3, the fuselage panel 10 comprises a part of the skin 14 of the fuselage, the longitudinal reinforcing segments 18, the transverse reinforcing segments 20 and may incorporate other reinforcements such as, for example, ones to frame the opening 26.

In the remainder of the description, the term reinforcement covers all types of reinforcements attached to the skin of an aircraft fuselage, such as, for example, a transverse reinforcement or a segment of a transverse reinforcement, a longitudinal reinforcement or segment of a longitudinal reinforcement, or any other reinforcement or part of a reinforcement.

In accordance with the invention, the skin 14 is made of metal. In one embodiment the skin 14 is made of aluminum alloy. Thus the skin 14 provides protection against lightning.

In accordance with the invention, the process of constructing an aircraft fuselage panel comprises the stages of:

shaping a metal sheet 30 according to the geometry of the skin 14 of the fuselage panel 10 which has to be obtained, and

overmolding at least one reinforcement 18, 20, 28.

Through the overmolding stage, the overmolded reinforcement or reinforcements 18, 20, 28 can be attached without making use of attached connecting members such as rivets, bolts, screws or other connections.

Overmolding comprises the stages of:

positioning the metal sheet 30 in a mold 32 comprising a cavity having the same geometry as that of the metal sheet 30 and at least one recess 34 having the same geometry as that of the reinforcement or reinforcements 18, 20, 28 which have to be overmolded, the recess or recesses 34 opening into the cavity,

injecting a material into the recess or recesses 34 to obtain at least one overmolded reinforcement 18, 20, 28,

turning out the metal sheet 30 fitted with the overmolded reinforcement or reinforcements 18, 20, 28.

In accordance with one embodiment, all reinforcements 18, 20, 28 constructed by overmolding are obtained during the same stage of injecting material.

Depending on the material injected, the mold 32 will only be opened after a stage of cooling the injected material.

Preferably the injected material is a resin or a plastics material. The choice of material will depend, in particular, on the mechanical properties desired from the overmolded reinforcement or reinforcements.

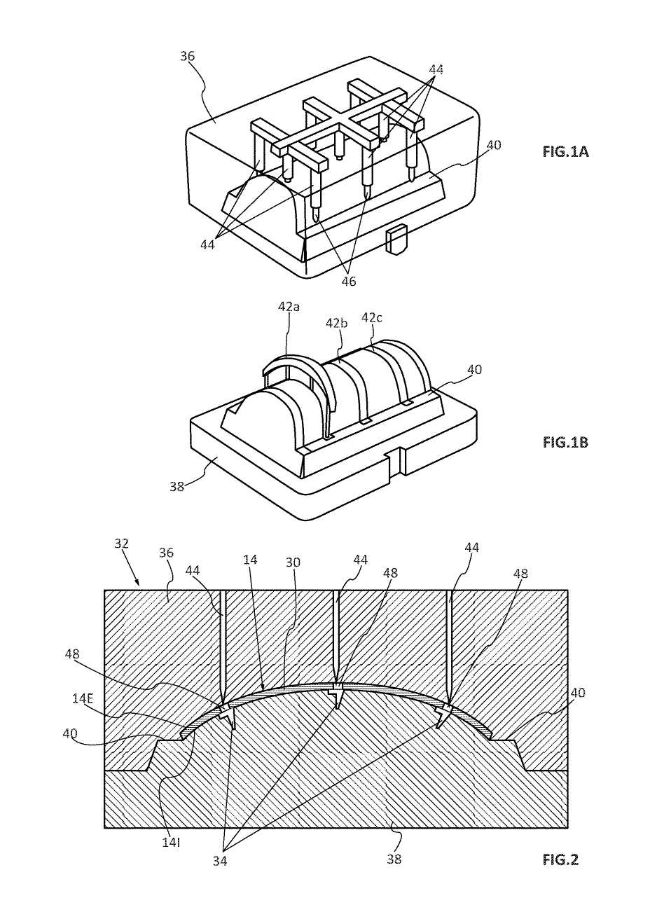

As illustrated in FIGS. 1A, 1B and 2, the mold 32 is made of at least two parts, a first shell 36 (which can be seen in FIG. 1A) and a second shell 38 (which can be seen in FIG. 1B) which can move with respect to each other in such a way as to occupy a closed position in which they bound a cavity which is leaktight to the injected material and a parted position in which the metal sheet 30 can be inserted into the cavity and the metal sheet 30 fitted with the overmolded reinforcement or reinforcements can be turned out.

The first and second shells 36 and 38 comprise surfaces 40, known as joint planes, which abut against each other to produce a cavity which is leaktight to the injected material.

The first and second shells 36 and 38 are mounted in an injection molding press which ensures that at least one of shells 36 and 38 will move. The injection molding press is not further described as this is known to those skilled in the art.

According to a first configuration illustrated in FIGS. 1A, 1B and 2, the first shell 36 comprises a concave shape corresponding to the outer surface 14E of the skin and the second shell 38 comprises a convex shape corresponding to the inner surface 141 of the skin and one or more recesses 34.

According to a first embodiment illustrated in FIG. 2, the overmolded reinforcements have shapes without undercuts so that they can be turned out of the mold.

In another embodiment, the overmolded reinforcements are undercut shapes. In this case, the mold 32 comprises at least one element which can move in relation to at least one shell, in particular, the second shell 38, such as rising blocks, slides or cores, for example, in order that turning out is possible.

Advantageously, the second shell 38 shown in FIG. 1B thus comprises three rising blocks 42a, 42b, 42c, which can be moved between two positions—a molding position in which rising blocks 42b and 42c are shown, and an ejection position in which the block 42a is shown. The blocks 42b and 42c are shown in the molding position, in which together with the second shell 38, they define a molding surface having an undercut shape, here a Z shape for molding the reinforcements 20. During turning out, the blocks move away from the remainder of the second shell 38, at the same time as the molded part, along an oblique trajectory defined by their guide rods, as a result of which they can release the molded undercut shape. Block 42a is thus shown in its turning-out position, connected to the rest of the second shell 38 by its guide rods.

In addition to this, centering elements may be provided to ensure accurate positioning of first and second shells 36 and 38. Preferably, at least one of shells 36 or 38 comprises at least one ejector to help the panel be turned out. In accordance with one embodiment, the ejectors comprise metal rods which move with respect to the shells during the turning out. These components, which are known to those skilled in the art, are not described in further detail.

The mold 32 also comprises at least one channel 44 for feeding the recess or recesses 34 with material and vents to vent off gases while the material is being injected.

Preferably each channel 44 comprises a nozzle 46 configured to control the flow of material in the direction of the recess or recesses 34. Advantageously this nozzle 46 is directable.

In accordance with another characteristic of the invention, the metal sheet 30 comprises at least one form to improve the strength of the connection between the overmolded reinforcement or reinforcements and the metal sheet 30. For this purpose, for each overmolded reinforcement, the metal sheet 30 comprises at least one opening 48 passing through the metal sheet 30 into which material is injected. Thus, for each opening 48, the overmolded reinforcement 18, 20, 28 comprises a protuberance 50 embedded in the metal sheet 30.

For each overmolded reinforcement, the number of openings 48 is determined in relation to the desired shear strength.

Preferably, each opening 48 has a cross-section which increases in size between the first surface of the metal sheet 30 (corresponding to the inner surface 141 of the skin) on which the overmolded reinforcement 18, 20, 28 is positioned, and a second surface of the metal sheet 30 opposite the first surface (corresponding to the outer surface 14E of the skin). Through this configuration, the tensile strength and the overall strength of the connection between the overmolded reinforcement or reinforcements and the metal sheet 30 forming the skin 14 can be increased.

The openings 48 have a cross-section at the level of inner surface 141 which is smaller than the size of the overmolded reinforcement so that the openings 48 are hidden under the overmolded reinforcements.

In accordance with one configuration, feed channels 44 open out at the openings 48. Thus the material is injected into the recess or recesses 34 by passing through the opening or openings 48 which ensures that the openings 48 are better filled with material and that there is thus a stronger embedded connection between the protuberance or protuberances 50 of the overmolded reinforcement and the metal sheet 30.

If the connection between the overmolded reinforcement or reinforcements and the metal sheet 30 is not sufficiently strong, attached connecting elements such as rivets, bolts or screws, for example, are provided to strengthen the connection. These connecting elements are much fewer than in the prior art because they are only used where necessary to reinforce the connection between the overmolded reinforcements and the metal sheet 30 obtained by the overmolding technique, which is already reinforced through the presence of the openings 48.

Preferably the overmolded reinforcements comprise inserts 52 such as pins, which may or may not be threaded, to allow components to be attached to the structure of the aircraft or to connect panels together as to form sections.

Thus, in accordance with one embodiment, the transverse reinforcing segments 20 comprise the inserts 52 at each of their extremities through which two successive transverse reinforcements can be connected using, for example, a splice plate 54.

Whereas the panel 10 comprises at least one opening 26, the metal sheet 30 includes as many cut-outs as there are openings 26, each cut-out having a geometry matching that of the corresponding opening. The shells 36 and 38 are in contact with each other within each opening 26 and a recess 34 is provided over the entire perimeter of opening 26.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A process for constructing an aircraft fuselage panel comprising a skin and at least one reinforcement attached to said skin, said skin being obtained by shaping a metal sheet according to the geometry of said skin, the process comprising the step of obtaining at least one reinforcement is by overmolding the reinforcement on the metal sheet.

2. The process as claimed in claim 1, wherein the step of overmolding comprises the stages of:
positioning the metal sheet in a mold comprising a cavity of the same geometry as that of said metal sheet and at least one recess having the same geometry as that of the at least one reinforcement which is to be overmolded, the at least one recess opening into the cavity,
injecting a material into the at least one recess so as to obtain the at least one overmolded reinforcement,
turning out the metal sheet provided with the at least one overmolded reinforcement from the mold.

3. The process as claimed in claim 2, wherein the metal sheet comprises, for at least one overmolded reinforcement, at least one opening passing through said metal sheet into which the material is injected, so that said overmolded reinforcement comprises a protuberance embedded in the metal sheet for each orifice.

4. The process as claimed in claim 3, wherein the opening has a cross-section which increases in size between a first surface of the metal sheet on which the overmolded reinforcement is positioned and a second surface of the metal sheet opposite the first surface.

5. The process as claimed in claim 3, wherein the material is injected into the recess or recesses passing through the at least one opening.

6. A mold for constructing an aircraft fuselage panel comprising a skin and at least one reinforcement attached to said skin comprising:
a first shell having a concave shape corresponding to a first surface of the skin of the fuselage panel,
a second shell comprising a convex shape corresponding to a second surface of the skin of the fuselage panel,
at least one of the first and second shells being capable of being moved so as to occupy a closed position in which the first and second shells bound a cavity having a geometry identical to that of the skin, and a parted position, the second shell comprising at least one recess having the same geometry as that of a reinforcement which has to be overmolded onto said skin.

7. The mold as claimed in claim 6, wherein the first shell comprises at least one feed channel for material to be injected, said channel being positioned in such a way as to open out into an opening provided in a metal sheet forming the skin and positioned in a cavity bounded by the first and second shells when in the closed position.

8. An aircraft fuselage panel formed by the process defined in claim 1.
